(19) United States
(12) Patent Application Publication
(10) Pub. No.: US 2005/0132364 A1
(43) Pub. Date: Jun. 16, 2005

(54) Method, apparatus and system for optimizing context switching between virtual machines

(76) Inventors: Vijay Tewari, Portland, OR (US); Robert C. Knauerhase, Portland, OR (US); Milan Milenkovic, Portland, OR (US)

Correspondence Address: INTEL CORPORATION, P.O. BOX 5326, SANTA CLARA, CA, 95056-5326, US

(21) Appl. No.: 10/738,526

(22) Filed: Dec. 16, 2003

(51) Int. Cl. G06F 9/455

(52) U.S. Cl. 718/1

(57) ABSTRACT

A method, apparatus and system may optimize context switching between virtual machines (“VMs”). According to an embodiment of the present invention, separate caches may be utilized to store and retrieve state information for each respective VM on a host. When the virtual machine manager (“VMM”) performs a context switch between a first and a second VM, the VMM may instruct the processor to point from one cache (associated with the first VM) to another (associated with the second VM). Since the caches are dedicated to their respective VMs, the state information for each VM may be retained, thus eliminating the overhead of restoring information from memory and/or disk.

### CROSS-REFERENCE TO RELATED APPLICATION

The present application is related to co-pending U.S. patent application Ser. No. ______, entitled “Method, Apparatus and System for Optimizing Context Switching Between Virtual Machines,” Attorney Docket Number P17836, assigned to the assignee of the present invention (and filed concurrently herewith).

### FIELD

The present invention relates to the field of processor virtualization, and, more particularly to a method, apparatus and system for optimizing context switching between virtual machines.

### BACKGROUND

Virtualization technology enables a single host running a virtual machine monitor (“VMM”) to present multiple abstractions of the host, such that the underlying hardware of the host appears as one or more independently operating virtual machines (“VMs”). Each VM may therefore function as a self-contained platform, running its own operating system (“OS”), or a copy of the OS, and/or a software application. The operating system and application software executing within a VM is collectively referred to as “guest software.” The VMM performs “context switching” as necessary to multiplex between various virtual machines according to a “round-robin” or some other predetermined scheme. To perform a context switch, the VMM may suspend execution of a first VM, optionally save the current state of the first VM, extract state information for a second VM and then execute the second VM.

### BRIEF DESCRIPTION OF THE DRAWINGS

The present invention is illustrated by way of example and not limitation in the figures of the accompanying drawings in which like references indicate similar elements, and in which:

FIG. 1 illustrates conceptually one embodiment of the present invention, comprising a processor with additional cache blocks;

FIG. 2 illustrates an embodiment of the present invention utilizing a multi-core processor; and

FIG. 3 is a flowchart illustrating an embodiment of the present invention.

### DETAILED DESCRIPTION

Embodiments of the present invention provide a method, apparatus and system for optimizing context switching between VMs. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

The VMM on a virtual machine host has ultimate control over the host's physical resources and, as previously described, the VMM allocates these resources to guest software according to a round-robin or some other scheduling scheme. Currently, when the VMM schedules another VM for execution, it suspends execution of the active VM, restores the state of a previously suspended VM from memory and/or disk into the processor cache, and then resumes execution of the newly restored VM. It may also save the execution state of the suspended VM from the processor cache into memory and/or disk. Storing and retrieving state information to and from memory and/or disk, and/or re-generating the state information from scratch, is a virtualization overhead that may result in delays that significantly degrade the host's overall performance and the performance of the virtual machines.

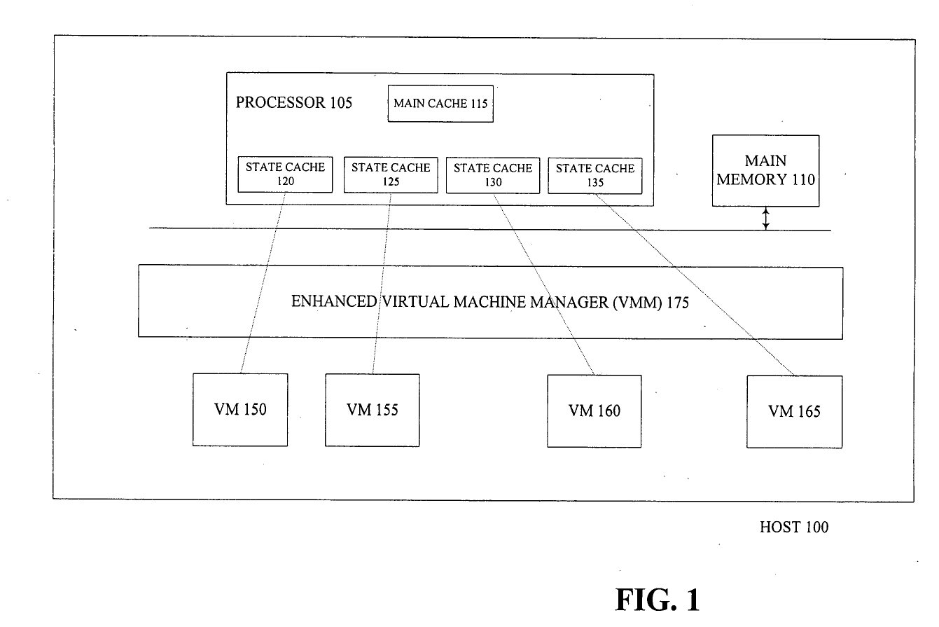

According to an embodiment of the present invention, additional cache blocks may be included on a processor to optimize context switching between VMs. Typically today, processors include only a single cache, used by multiple VMs in the manner described above. In one embodiment of the present invention, multiple cache blocks may be added to the processor, thus enabling each VM to be associated with its own cache. FIG. 1 illustrates conceptually such an embodiment. Specifically, as illustrated, Host 100 may include Processor 105, Main Memory 110 and Main Cache 115. Additionally, according to an embodiment of the present invention, Host 100 may also include a bank of caches, illustrated as State Caches 120-135 (hereafter referred to collectively as “State Caches”).

In one embodiment of the present invention, each of the State Caches may be associated with a VM (illustrated as “VM 150”-“VM 165”) running on Host 100, and VM 150-VM 165 may be managed by Enhanced VMM 175. Thus, in the illustrated example, VM 150 may be associated with State Cache 120, VM 155 may be associated with State Cache 125, VM 160 may be associated with State Cache 130 and VM 165 may be associated with State Cache 135. In one embodiment, while Processor 105 is running VM 150, it may utilize the information in State Cache 120, the current “working cache”. When Enhanced VMM 175 determines that it needs to perform a context switch to VM 155, instead of having to restore the state of VM 155 into the current working cache (State Cache 120) that contains the state information for VM 150, Enhanced VMM 175 may simply instruct Processor 105 to switch to State Cache 125. In other words, according to one embodiment, in order to perform a context switch, Enhanced VMM 175 may instruct Processor 105 to point away from the current cache (State Cache 120) and point to a new cache (State Cache 125), which contains the state information for VM 155. This switching of working caches thus effectively suspends VM 150 and allows VM 155 to execute immediately, since State Cache 125 includes all of VM 155's state information. By allocating a cache to each virtual machine, and allowing the caches to retain the state information for the respective virtual machines, embodiments of the present invention may significantly minimize the overhead of context switching.

In one embodiment of the present invention, Processor 105 itself may be enhanced to include additional logic and/or instructions that Enhanced VMM 175 may use to instruct Processor 105 to switch from one State Cache to another. In an alternate embodiment, enhancements may be incorporated into Enhanced VMM 175 to facilitate the switch. It will be readily apparent to those of ordinary skill in the art that instructing Processor 105 to point to a specific cache may be implemented in a variety of other ways without departing from the spirit of embodiments of the present invention. Thus, for example, in one embodiment, additional hardware may be implemented on Host 100 to copy the contents of the State Caches to memory and/or disk in parallel with execution of the new VM. Since this copying occurs simultaneously with the execution of the new VM, the context switching overhead may still be minimized.

It will be readily apparent to those of ordinary skill in the art that when each of the VMs on Host 100 first start executing (i.e., the first time they execute upon startup), the corresponding state caches for the VMs may be empty. Thus, the initial context switching from one VM to another may still experience a context switching overhead. In one embodiment of the present invention, each of the state caches may be pre-populated upon execution of the first VM on Host 100. In other words, when the first VM begins executing on Host 100, the other VMs on the host may begin pre-populating their respective State Caches with relevant information (speculative or otherwise). As a result, when a context switch occurs for the first time, the State Caches may include state information corresponding to the new VM and the new VM may begin execution immediately.

Embodiments of the present invention may additionally be implemented on a variety of processors, such as multi-core processors and/or hyperthreaded processors. Thus, for example, although multi-core processors typically include a single cache, available to all the processor cores on the chip, in one embodiment, multiple cache banks may be included in a multi-core processor. “Multi-core processors” are well known to those of ordinary skill in the art and include a chip that contains more than one processor core. Each processor core may run one or more VMs, and each VM may be assigned to a specific cache in the bank of caches.

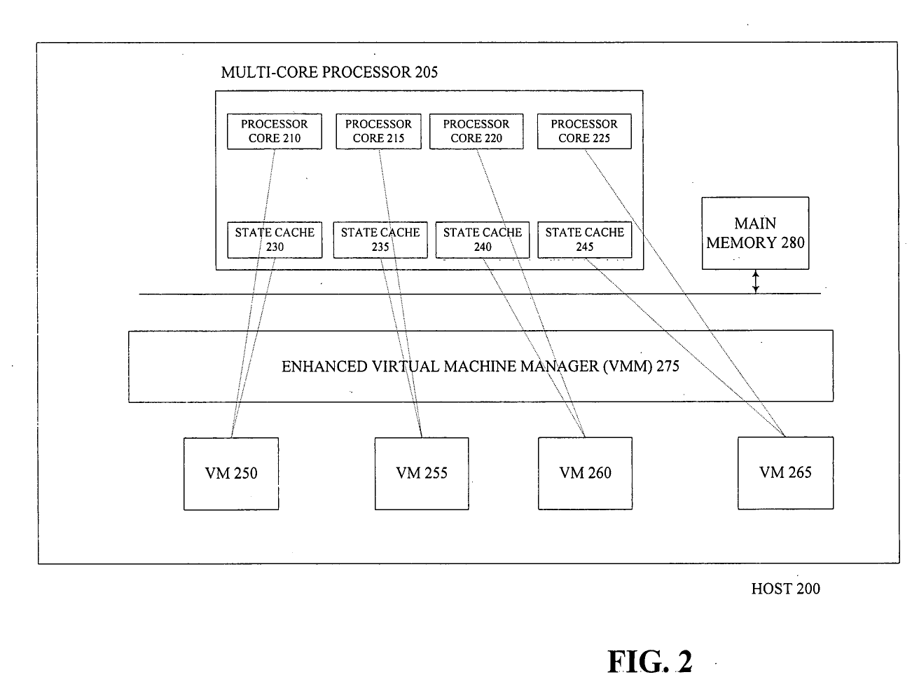

This embodiment is illustrated conceptually in FIG. 2. As illustrated, Host 200 may include Multi-Core Processor 205 comprising multiple processor cores (“Processor Core 210”, “Processor Core 215”, “Processor Core 220” and “Processor Core 225”), hereafter collectively “Processor Cores”). Although only four processor cores are illustrated, it will be readily apparent to those of ordinary skill in the art that more (or less) cores may be implemented. Multi-Core Processor 205 may additionally include Main Memory 280 and a bank of caches, illustrated as State Caches 230-245.

As in previous embodiment, each of the State Caches may be associated with a VM (illustrated as “VM 250”, “VM 255”, “VM 260” and “VM 265”). In this embodiment, however, each VM may also be associated with one of the Processor Cores on Multi-Core Processor 205. Thus, in the illustrated example, Processor Core 210 may run VM 250 and be associated with State Cache 230, Processor Core 215 may run VM 255 and be associated with State Cache 235, Processor Core 220 may run VM 260 and be associated with State Cache 240 and Processor Core 225 may run VM 265 and be associated with State Cache 245. In one embodiment, Enhanced VMM 275 may manage the VMs on the various Processor Cores and keep track of the State Caches assigned to each VM. Thus, when Enhanced VMM 275 determines it needs to perform a context switch, e.g., from VM 250 to VM 255, it may instruct Processor Core 210 to stop executing and accessing information from State Cache 230. Enhanced VMM 275 may additionally instruct Processor Core 260 to start executing VM 255 and to retrieve state information for VM 255 from Sate Cache 235. Thus, again, by allocating a cache to each VM, and allowing the caches to retain the state information for the respective VMs, embodiments of the present invention may significantly minimize the overhead of context switching.

In one embodiment of the present invention, more VMs may exist on a host than State Caches and as a result, each VM may not necessarily be associated with specific State Caches. According to an embodiment, Enhanced VMM 275 may dynamically manage the assignment of State Caches to VMs, to ensure a State Cache with correct information for “incoming” (i.e., next to execute) VM is always present when (or prior to when) it is needed. In one embodiment, Enhanced VMM 275 may dynamically allocate and deallocate the State Caches to and from the VMs according to the order in which the VMs are scheduled to execute. In an alternate embodiment, Enhanced VMM 275 may be provided with allocation and deallocation information upon startup. Other modes of managing the assignment of State Caches to VMs may also be implemented without departing from embodiments of the present invention.

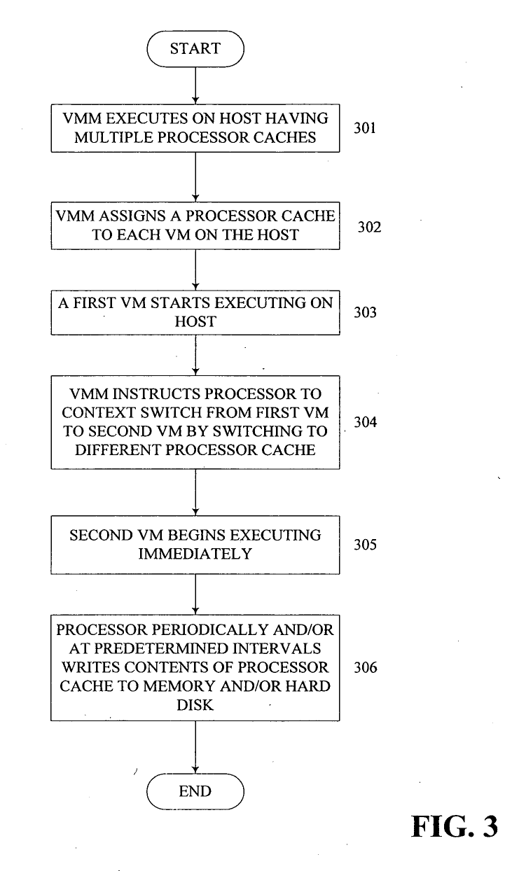

FIG. 3 is a flow chart of an embodiment of the present invention. Although the following operations may be described as a sequential process, many of the operations may in fact be performed in parallel and/or concurrently. In addition, the order of the operations may be re-arranged without departing from the spirit of embodiments of the invention. In 301, a VMM may execute on a virtual machine host having multiple processor caches and in 302, the VMM may assign a processor cache to each VM on the host. A first VM may start executing on the host in 303, and in 304, the VMM may instruct the processor on the host to context switch from the first VM to a second VM by switching to a different processor cache (assigned to the second VM). In 305, the second VM may begin executing immediately utilizing the state information from its cache, and in 306, the VMM may periodically and/or at predetermined intervals instruct the processor to write the contents of its cache to memory and/or hard disk.

The hosts according to embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. As previously described, these computing devices may include processors with additional banks of cache and/multi-core processors and/or hyperthreaded processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the computing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. An apparatus for optimizing context switching between virtual machines, comprising:
a processor capable of executing a virtual machine manager (“VMM”), a first virtual machine (“VM”) and a second VM;
a first state cache coupled to the processor, the first state cache including the state information for the first VM; and
a second state cache coupled to the processor, the second state cache including the state information for the second VM, the VMM capable of instructing the processor to execute the first virtual machine, the VMM further capable of instructing the processor to context switch from the first VM to the second VM by switching from the first state cache to the second state cache, the VMM further capable of instructing the processor to immediately begin executing the second VM.

2. The apparatus according to claim 1 wherein the first state cache is dedicated to the first VM and the second state cache is dedicated to the second VM.

3. The apparatus according to claim 1 wherein the VMM dynamically allocates the first state cache to the first VM and the second state cache to the second VM.

4. The apparatus according to claim 1 wherein the processor is a multi-core processor.

5. The apparatus according to claim 4 wherein the multi-core processor includes a first processor core associated with the first VM and a second processor core associated with the second VM.

6. The apparatus according to claim 1 wherein the processor is a hyperthreaded processor.

7. The apparatus according to claim 1 wherein the first state cache retains the state information for the first VM while the second VM is executing.

8. The apparatus according to claim 1 further comprising a main storage location coupled to the processor, the first state cache and the second state cache.

9. The apparatus according to claim 8 wherein the VMM writes the contents of the first state cache to the main storage location when the processor context switches from the first VM to the second VM.

10. The apparatus according to claim 8 wherein the second state cache retrieves the state information for the second virtual machine from the main storage location while the first VM is executing.

11. The apparatus according to claim 8 wherein the main storage location is at least one of a main memory and a hard disk.

12. A method of optimizing context switching between virtual machines, comprising:
executing a first virtual machine (“VM”) based on first state information in a first state cache associated with the first VM;
instructing a processor to switch from accessing the first state information in the first state cache to accessing second state information in a second state cache associated with a second VM; and
executing the second VM immediately based on the second state information in the second state cache.

13. The method according to claim 12 further comprising retaining the first state information in the first state cache while the second VM is executing.

14. The method according to claim 12 further comprising retrieving the second state information from a main storage location while the first VM is executing.

15. The method according to claim 14 further comprising writing the first state information in the first state cache to the main storage location while the second VM is executing.

16. The method according to claim 12 further comprising dedicating the first state cache to the first VM and the second state cache to the second VM.

17. The method according to claim 16 further comprising dynamically allocating the first state cache to the first VM and the second state cache to the second VM.

18. An article comprising a machine-accessible medium having stored thereon instructions that, when executed by a machine, cause the machine to:
execute a first virtual machine (“VM”) based on first state information in a first state cache associated with the first VM;
instruct a processor to switch from accessing the first state information in the first state cache to accessing second state information in a second state cache associated with a second VM; and
execute the second VM immediately based on the second state information in the second state cache.

19. The article according to claim 18 wherein the instructions, when executed by the machine, further cause the machine to retain the first state information in the first state cache while the second VM is executing.

20. The article according to claim 18 wherein the instructions, when executed by the machine, further cause the machine to retrieve the second state information from a main storage location while the first VM is executing.

21. The article according to claim 20 wherein the instructions, when executed by a machine, further cause the machine to write the first state information in the first state cache to the main storage location while the second VM is executing.

22. The article according to claim 18 wherein the instructions, when executed by the machine, further cause the machine to dedicate the first state cache to the first VM and the second state cache to the second VM.

23. The article according to claim 18 wherein the instructions, when executed by the machine, further cause the machine to dynamically allocate the first state cache to the first VM and the second state cache to the second VM.

24. A system for optimizing context switching between virtual machines, comprising:
a host device including a processor capable of executing a first virtual machine (“VM”) and a second VM;
a virtual machine manager (“VMM”) executing on the host device; and
a bank of state caches coupled to the processor and the VMM, the bank of state caches including a first state cache and a second state cache, the first state cache including state information for the first virtual machine and the second state cache including state information for the second virtual machine, the VMM capable of context switching between the first VM and the second VM by causing the processor switch from pointing to the first state cache to pointing to the second state cache.

25. The system according to claim 24 wherein the first state cache is dedicated to the first VM and the second state cache is dedicated to the second VM.

26. The system according to claim 24 wherein the second VM begins executing immediately after the processor switches to pointing to the second state cache.

27. The system according to claim 24 wherein the host device is further capable of executing a third VM and the bank of state caches includes a third state cache including state information for the third VM.

28. The system according to claim 24 further comprising a main storage location coupled to the processor, the VMM and the bank of state caches.

29. The system according to claim 28 wherein the second state cache is capable of retrieving state information for the second VM from the main storage location while the first VM is executing.

30. The system according to claim 28 wherein the VMM is capable of writing the state information for the first VM in the first state cache to the main storage location while the second VM is executing.
